(19) United States
(12) Patent Application Publication
(10) Pub. No.: US 2009/0255379 A1
(43) Pub. Date: Oct. 15, 2009

(54) UNIVERSAL SOCKET

(76) Inventor: CHIH-CHING HSIEH, Taichung City (TW)

Correspondence Address: Chien-Hui Su, P. O. Box 70-121 Taichung, Taichung City, 40899, TW

(21) Appl. No.: 12/100,423

(22) Filed: Apr. 10, 2008

(51) Int. Cl. B25B 13/06

(52) U.S. Cl. 81/124.5

(57) ABSTRACT

A universal socket includes a first socket, a second socket, and a rivet. The first socket has a fitting hole defined in one end and a receiving recess defined in the other end thereof. A through hole is diametrically defined in the first socket and communicating with the receiving recess. A second socket has a ball member formed thereon and disposed in the receiving recess. A slot is diametrically defined in and extends through the ball member. The slot communicates with the through hole when the ball member is received in the receiving recess. A rivet has a head and a forming head, wherein the rivet extends through the through hole and the slot to retain the ball member disposed in the receiving recess and preventing the second socket from disengaging from the first socket.

### FIELD OF THE INVENTION

The present invention relates to a universal socket, and particularly to a simple structure and cost-saving universal socket. Furthermore the universal socket prevents from disengagement accidentally.

### BACKGROUND OF THE INVENTION

Prior art universal socket includes a coupling having a bore for engaging the shaft of a wrench and a socket part having an appropriately shaped socket for engaging a nut. The coupling includes a cavity for engaging a ball member disposed at one end of the socket part, and a cross pin extending diametrically through the ball member and the casement of the coupling to retain the ball member in the cavity and to provide the torque transmitting connection between the coupling and the socket part.

However, the prior art still has some defects. The pin may fall out, or partially emerge from the coupling so as to weaken the torque transmitting connection to the socket part. If the pin falls out, the coupling and the socket part will disengage. Some prior arts add sleeve or equivalents to prevent from disengagement accidentally, but this will increase the manufacturing cost and assembling process. Thus there is an eager demand for a novel design which can improve the defects in the prior art.

### SUMMARY OF THE INVENTION

Accordingly, the primary object of the present invention is to provide a universal socket, in that a simple structure and low cost universal socket is obtained.

To achieve the above objectives, the universal socket in accordance with the present invention comprises a first socket having a fitting hole defined in one end and a receiving recess defined in the other end thereof. A through hole is diametrically defined in the first socket and communicating with the receiving recess. A second socket has a ball member formed thereon and disposed in the receiving recess. A slot is diametrically defined in and extends through the ball member. The slot communicates with the through hole when the ball member is received in the receiving recess. A rivet has a head and a forming head, wherein the rivet extends through the through hole and the slot to retain the ball member disposed in the receiving recess and prevent the second socket from disengaging from the first socket.

The various objectives and advantages of the present invention will be more readily understood from the following detailed description when read in conjunction with the appended drawing.

### BRIEF DESCRIPTION OF THE DRAWINGS

FIG. 1 is an exploded perspective view of a universal socket in accordance with the present invention.

FIG. 2 is a perspective view of the universal socket in accordance with the present invention.

FIG. 3 shows the operation of the universal socket coordinated with a torque wrench.

FIG. 4 shows the operation of the universal socket coordinated with a T-shaped wrench.

FIG. 5 is a partially exploded perspective view of a second embodiment of the universal socket in accordance with the present invention.

FIG. 6 is a partially exploded perspective view of a third embodiment of the universal socket in accordance with the present invention.

FIG. 7 is a perspective view of a forth embodiment of the universal socket in accordance with the present invention.

FIG. 8 is an operational view of the universal socket in FIG. 7.

### DETAILED DESCRIPTION OF THE INVENTION

In order that those skilled in the art can further understand the present invention, a description will be provided in details below. However, these descriptions and the appended drawings are only used for those skilled in the art to understand the objects, features, and characteristics of the present invention, but not to be used to confine the scope and spirit of the present invention defined in the appended claims.

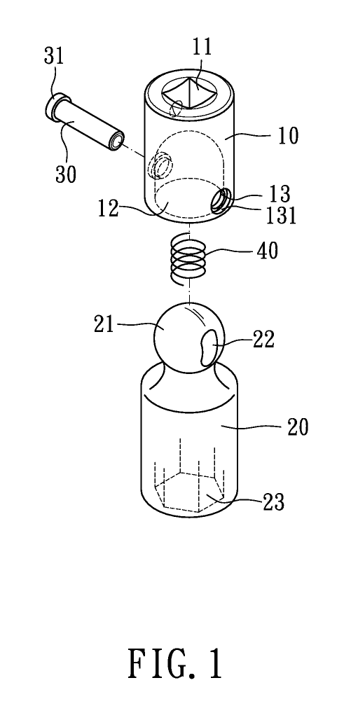

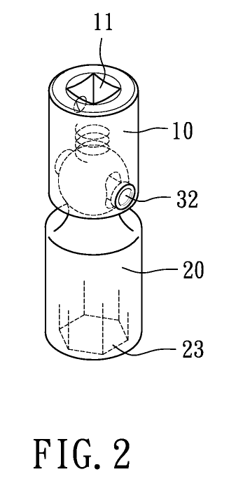

Referring FIGS. 1 and 2, a universal socket according to the present invention is illustrated. The universal socket includes a first socket 10, a second socket 20 universally connected to the first socket, a rivet 30 extending through the first socket 10 and the second socket 20, and a spring 40 disposed between the first socket 10 and the second socket 20 to bias the second socket 20.

The first socket 10 includes a fitting hole 11 defined in one end and a receiving recess 12 defined in the other end thereof, wherein the fitting hole 11 and the receiving recess 12 co-axially correspond to each other. The fitting hole 11 is in a shape of square and adapted for engaging to a driving head of the wrench. The receiving recess 12 is cylindrical at an open end and is semi-spherical at a close end. A through hole 13 is diametrically defined in the first socket 10 and passes through the receiving recess 12. The through hole 13 includes two countersinks 131 respectively defined in two opposite ends thereof.

The second socket 20 includes a ball member 21 formed thereon and received in the receiving recess 12. A slot 22 is defined in and extends through the ball member 21. The slot 22 is enlarged the dimension at two opposite ends thereof and communicating with the through hole 13 when the ball member 21 is received in the receiving recess 12. The second socket 20 includes a driving hole 23 defined therein opposite to the ball member 21 and co-axially corresponding to the ball member 21. The driving hole 23 in this embodiment is in a shape of hexagon for driving a nut or a screw.

The rivet 30 extends through the through hole 13 and the slot 22 to retain the ball member 21 after the ball member 21 being disposed in the receiving recess 12. A head 31 and a forming head 32 are respectively formed on two opposite ends of the rivet 30 and respectively received in a corresponding one of the two countersinks 131 to prevent from falling out so the first socket 10 and the second socket 20 will not disengage from each other.

The spring 40 is positioned between a bottom of the receiving recess 12 and the ball member 21 to bias the second socket 20.

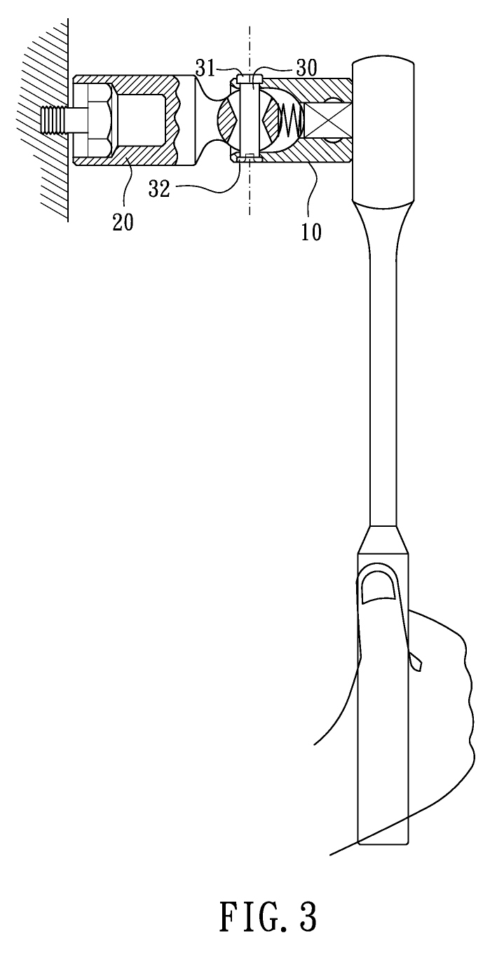

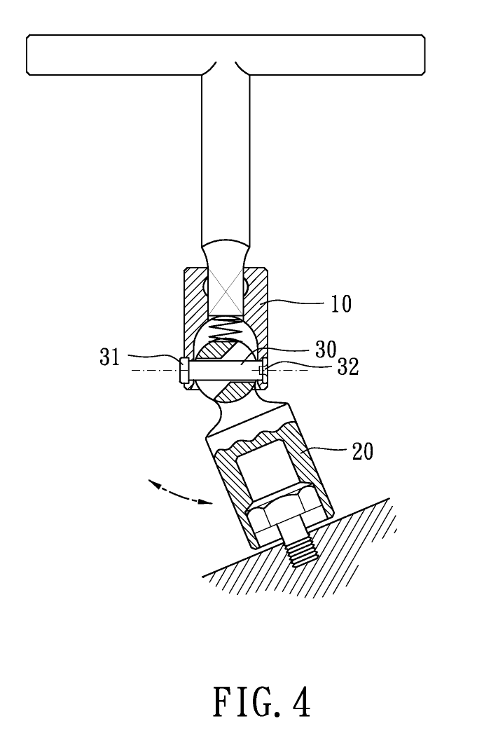

FIGS. 3 and 4 show the operation of the first embodiment in accordance with the present invention. The fitting hole 11 is adapted to connect with a torque wrench or a T-shaped wrench. The driving head 23 is adapted to drive a screw. When operating the universal socket in accordance with the present invention, the rivet 30 is fixed by the head 31 and the forming head 32, and the first socket 10 and the second socket 20 are fastened by the rivet 30. Therefore the rivet 30 will not fall out and the first socket 10 and the second socket 20 will not disengage from each other.

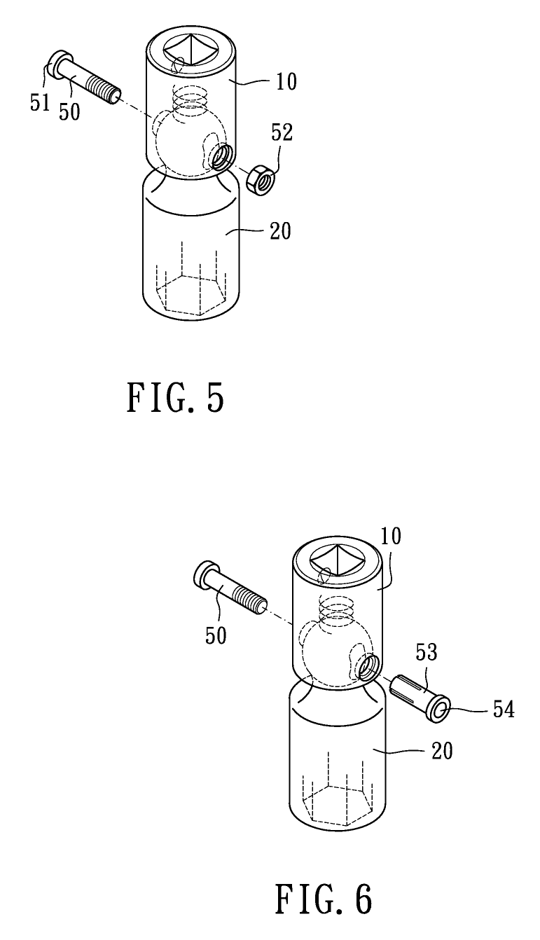

FIG. 5 shows the second embodiment according to the present invention. In this embodiment, those identical to the above embodiment will not be further described herein. Only those different from above embodiment are described. In this embodiment, a screw 50 passes through the through hole 13 and the slot 22, and fastens by a nut 52, that is screwed onto the screw 50 to retain the ball member 21 disposed in the receiving recess 12. A head 51 formed on one end of the screw 50 and the nut 52 are respectively received in a corresponding one of the two countersinks 131 to prevent from falling out so the first socket 10 and the second socket 20 will not disengage from each other.

FIG. 6 shows the third embodiment according to the present invention. In this embodiment, the screw 50 passes through the through hole 13 and the slot 22 and fastens by a screw anchor 53 to retain the ball member 21 disposed in the receiving recess 12. The head 51 of the screw 50 and a head 54 formed on one end of the screw anchor 53 are respectively received in a corresponding one of the two countersinks 131 to prevent from falling out so the first socket 10 and the second socket 20 will not disengage from each other.

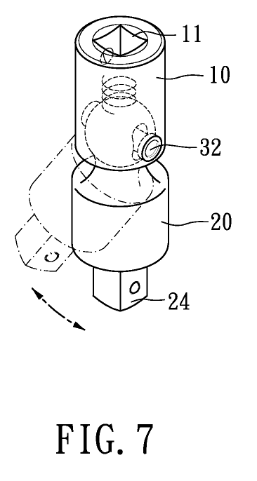

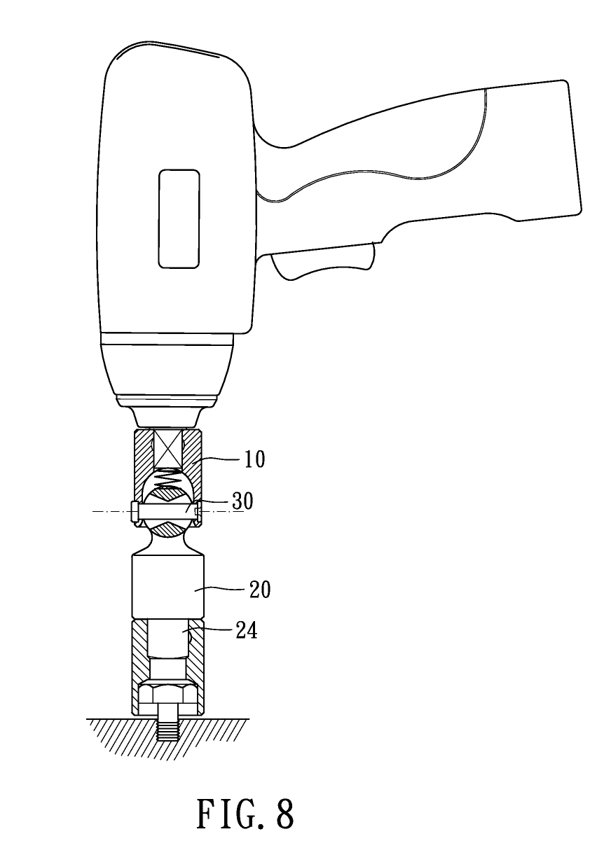

FIG. 7 shows the forth embodiment according to the present invention. In this embodiment, the second socket 20 includes a driving head 24 centrally extending therefrom opposite to the ball member 21 and adapted to connect with a socket or equivalents as shown in FIG. 8.

However, above mentioned embodiments are just examples of the present invention, they are not confined the scope of the present invention. The forms of the driving head and the receive port may be varied as desired.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A universal socket comprising:
a first socket having a fitting hole defined in one end and a receiving recess defined in the other end thereof, a through hole diametrically defined in the first socket and communicating with the receiving recess;
a second socket having a ball member formed thereon and disposed in the receiving recess, a slot diametrically defined in and extending through the ball member, the slot communicated with the through hole when the ball member is received in the receiving recess; and
fasten means for retaining the ball member disposed in the receiving recess and preventing the second socket from disengaging from the first socket.

2. The universal socket as claimed in claim 1, wherein the second socket includes a driving hole defined therein opposite to the ball member and co-axially corresponding to the ball member.

3. The universal socket as claimed in claim 1, wherein the second socket includes a driving head centrally extending therefrom opposite to the ball member.

4. The universal socket as claimed in claim 1, wherein the fasten means is a rivet having a head and a forming head.

5. The universal socket as claimed in claim 1, wherein the fasten means is a screw having a head and a nut.

6. The universal socket as claimed in claim 1, wherein the fasten means is a screw having a head and a screw anchor having a head.

7. The universal socket as claimed in claim 1, wherein the through hole includes a countersink in two opposite ends thereof.
